(19) United States
(12) Patent Application Publication
(10) Pub. No.: US 2014/0028835 A1
(43) Pub. Date: Jan. 30, 2014

(54) OBJECT RANGING APPARATUS AND IMAGING APPARATUS

(71) Applicant: CANON KABUSHIKI KAISHA, Tokyo (JP)

(72) Inventor: Atsushi Sugawara, Tokyo (JP)

(73) Assignee: CANON KABUSHIKI KAISHA, Tokyo (JP)

(21) Appl. No.: 13/949,718

(22) Filed: Jul. 24, 2013

(30) Foreign Application Priority Data
Jul. 26, 2012 (JP) 2012-165337

(51) Int. Cl. G06T 7/00

(52) U.S. Cl. CPC G06T 7/004
USPC 348/135

(57) ABSTRACT

An object ranging apparatus includes a first ranging unit configured to, based on movement locus information including a series of loci of positions to which an object is predicted to move, perform ranging at a plurality of predicted positions on the loci, a storage unit configured to store results of ranging at the plurality of predicted positions, and a control unit configured to, when the object reaches the predicted positions in an actual image capturing operation, perform a focusing operation based on the results of ranging at the predicted positions.

### BACKGROUND OF THE INVENTION

1. Field of the Invention

The present invention relates to an object ranging apparatus and an imaging apparatus including the object ranging apparatus. More particularly, the present invention relates to an object ranging apparatus for recognizing a movement locus of an object in advance and tracking the object by using movement locus information including positional information of the object, and to an imaging apparatus, including the object ranging apparatus, for capturing an image of the imaging target object.

2. Description of the Related Art

Conventionally, it has not been easy to capture a moving object's image because it requires not only high-speed exposure control and focusing (focus adjustment state) control but also prediction in consideration of a time lag between ranging and exposure. In the present specification, a case where focus adjustment is performed but ranging is not may be also referred to as ranging. However, in capturing a moving object's image under such situations as athletic sports, motor sports, athletic meets, and electric train photographing, the movement locus of a tracking target object is predictable since the object moves along a predetermined locus, such as a running track, a circuit course, and a rail track. Thus, if a camera prestores movement locus information of the object, the information will be useful in performing difficult moving object's image capturing. Some cameras are provided with a touch panel liquid crystal display (LCD). Using such a touch panel interface allows a user to pre-input a motion of a tracking target moving object to a camera by tracing the movement locus of the object on the touch panel with the composition fixed. An example case of an auto race is illustrated in FIG. 1. In this case, the tracking target object is a car and its locus has a shape of a hairpin curve along with the circuit course. Therefore, the user can input movement locus information to the camera by tracing the arrow illustrated in FIG. 1 on the touch panel.

On the other hand, some digital cameras and digital camcorders are provided with the live view mode in which image data is sequentially output from an image sensor to a display apparatus, such as a back LCD, allowing the user to observe the state of an object in real time. Further, generally with a digital single-lens reflex camera in which light does not come to an image sensor other than the time of exposure, an automatic exposure (AE) sensor for performing light metering is capable of acquiring an image signal of an object at a timing other than the exposure timing. Thus, the object can be observed in real time like in the live view mode. Further, the image signal of the object containing higher resolution color information may be constantly acquired by providing an AE image sensor with the number of pixels increased or using a color filter, or by providing a similar image sensor, different from the AE sensor, for observing the object.

With the above-described configuration in which the image signal of the object can be acquired in real time, applying suitable processing and operations to the image signal enables the digital camera and digital camcorder to automatically determine a range where the tracking target object exists and to continue tracking the object. A technique discussed in U.S. Pat. No. 8,253,800 (corresponding to Japanese Patent Application Laid-Open No. 2008-46354) registers an area in the proximity of a focused ranging point having the same hue as a target, and, based on the hue information, calculates a position of the object in the screen to track the object. Detecting in real time a position where an object exists enables exposure and focusing control optimized for the position of the imaging target object when releasing a shutter button. Therefore, providing an object tracking function is remarkably advantageous for an imaging apparatus since the function leads to reduction in the number of failed photographs.

However, with the above-described configuration, if an object having similar hue to that of the tracking target object exists in other parts of the screen, the object tracking function may recognize and track the relevant object as a tracking target object.

### SUMMARY OF THE INVENTION

According to an aspect of the present invention, an object ranging apparatus includes a first ranging unit configured to, based on movement locus information including a series of loci of positions to which an object is predicted to move, perform ranging at a plurality of predicted positions on the loci, a storage unit configured to store results of ranging at the plurality of predicted positions, and a control unit configured to, when the object reaches the predicted positions in an actual image capturing operation, perform a focusing operation based on the results of ranging at the predicted positions.

According to exemplary embodiments of the present invention, the tracking accuracy is improved by performing calculations for tracking a tracking target object based on prepared movement locus information including information about the position of the tracking target object.

Further features of the present invention will become apparent from the following description of exemplary embodiments with reference to the attached drawings.

### BRIEF DESCRIPTION OF THE DRAWINGS

FIG. 1 illustrates an example of an image to be captured of a tracking target object.

FIG. 2 is a cross sectional view illustrating a camera according to an exemplary embodiment of the present invention.

FIGS. 3A and 3B illustrate a layout of ranging points (focus detection regions) of a phase-difference automatic focus (AF) sensor of the camera according to the exemplary embodiment of the present invention.

FIG. 4 is a flowchart illustrating processing according to the exemplary embodiment of the present invention.

FIGS. 5A and 5B illustrate a range subjected to an AF operation based on a contrast detection system according to the exemplary embodiment of the present invention.

### DESCRIPTION OF THE EMBODIMENTS

Exemplary embodiments of the present invention are characterized in that, by using movement locus information including information about a position to which an object is predicted to move within a composition, image information of the detected object is compared with image information for at least the above-described predicted position to perform calculations for object tracking, thus identifying a position of the object at each timing. Specifically, calculation for object tracking is performed preferentially in a region for the direction in which the object is assumed to have moved, based on the movement locus information of the object. An imaging apparatus, such as a camera, can be configured to include this object ranging apparatus.

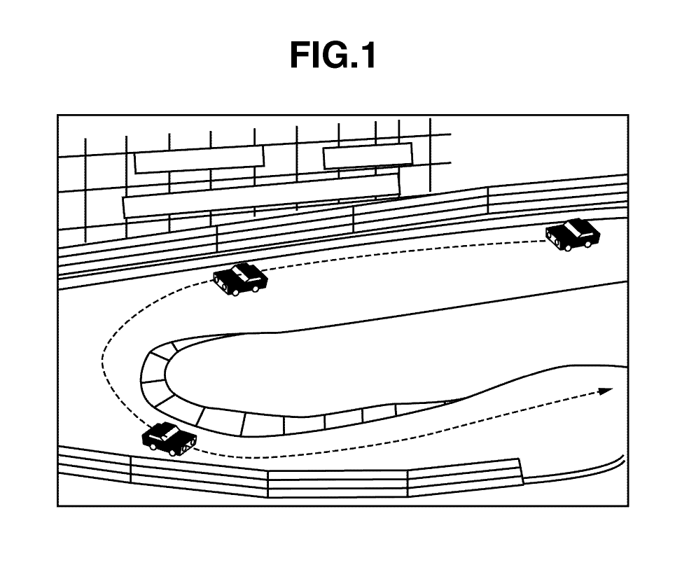

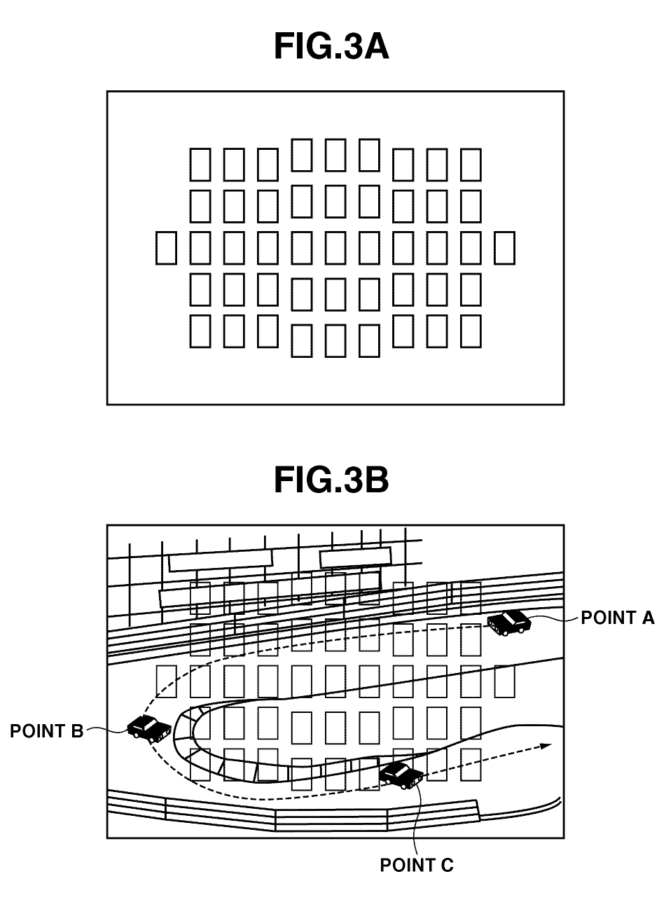

A first exemplary embodiment will be described below with reference to the accompanying drawings. The present exemplary embodiment describes a digital single-lens reflex camera capable of automatic focusing based on the phase-difference AF system, having a 47-ranging point layout for the finder, as illustrated in FIG. 3A. In the following descriptions, capturing an image of a car turning at a hairpin curve of a circuit as illustrated in FIG. 1 is assumed as an example imaging situation.

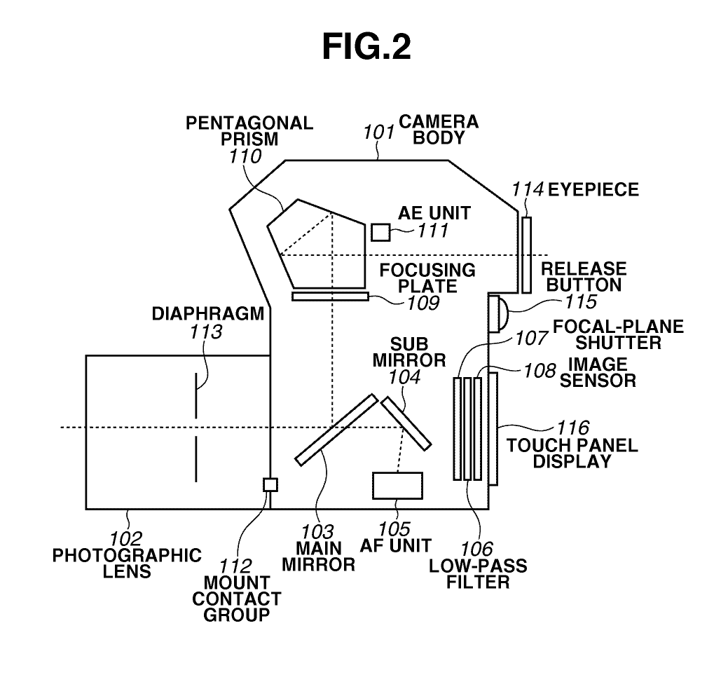

FIG. 2 is a cross sectional view illustrating the digital single-lens reflex camera according to the present exemplary embodiment. Referring to FIG. 2, a photographic lens 102 is mounted on the front surface of a camera body 101. The photographic lens 102 is an interchangeable lens, which is electrically connected with the camera body 101 via a mount contact group 112. The photographic lens 102 includes a diaphragm 113 for adjusting the amount of light captured into the camera. A main mirror 103 is a half mirror. In the finder observation state, the main mirror 103 is obliquely disposed on the imaging optical path, and reflects the imaging light flux from the photographic lens 102 to the finder optical system. On the other hand, the transmitted light enters an AF unit 105 via a sub mirror 104. In the imaging state, the main mirror 103 is retracted outside the imaging optical path.

The AF unit 105 is a phase-difference detection AF sensor having a ranging point layout as illustrated in FIG. 3A. The phase-difference detection AF system is a well-known technique, and detailed description of control will be omitted. An outline is that the phase-difference detection AF system detects the focus adjustment state of the photographic lens 102 (i.e., performs ranging) by forming a secondary image forming plane of the photographic lens 102 on a focus detection line sensor, and, based on the result of the detection, drives a focus lens (not illustrated) to perform automatic focusing detection or adjustment. An image sensor 108 forms an image of the imaging light flux from the photographic lens 102. The camera body 101 also includes a low-pass filter 106 and a focal-plane shutter 107.

The finder optical system includes a focusing plate 109 disposed on an expected image forming plane of the photographic lens 102, a pentagonal prism 110 for changing the finder optical path, and an eyepiece 114 through which a photographer observes the focusing plate 109 to monitor the photographing screen. An AE unit 111 is used to perform light metering. The AE unit 111 is assumed to include red, green, and blue (RGB) pixels of the Quarter Video Graphics Array (QVGA) (320×240=76,800 pixels), and be capable of capturing a real-time image signal of an object.

A release button 115 is a two-step push switch having the half press and full press states. When the release button 115 is half-pressed, shooting preparation operations, such as AE and AF operations, are performed. When the release button 115 is full-pressed, the image sensor 108 is exposed to light and imaging processing is performed. Hereinafter, the half press state of the release button 115 is referred to as the ON state of a switch 1 (SW1), and the full press state thereof is referred to as the ON state of a switch 2 (SW2). A touch panel display 116 is attached to the rear surface of the camera body 101. The touch panel display 116 allows the photographer to perform an operation for pre-inputting the movement locus of the imaging target object as described above, and to directly observe a captured image.

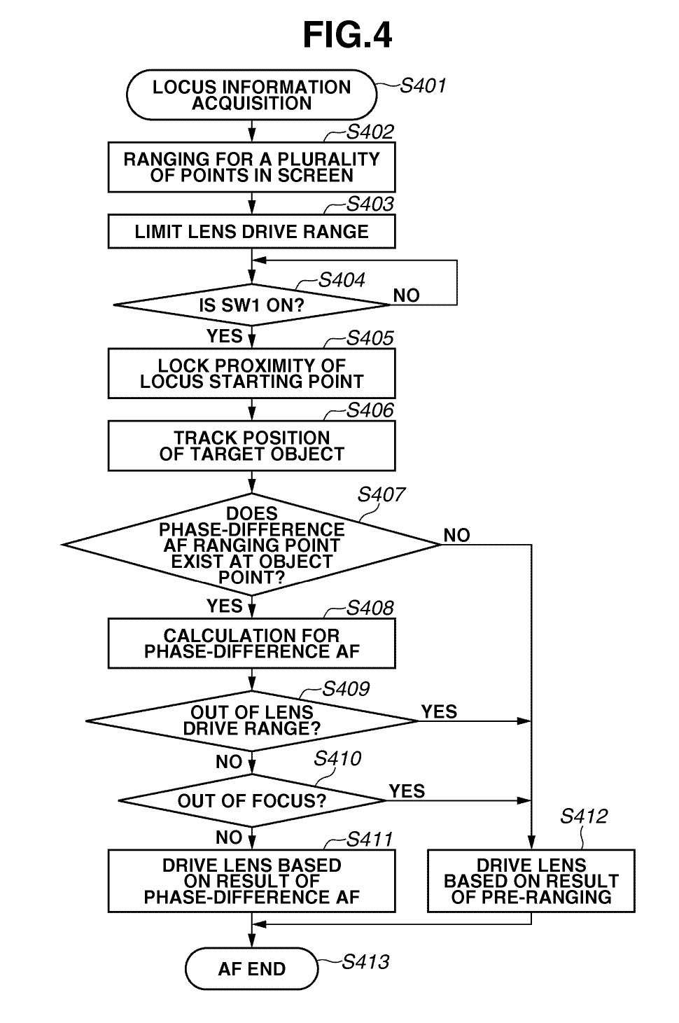

Operations of the camera according to the present exemplary embodiment will be described below with reference to a flowchart illustrated in FIG. 4. Such operations are controlled and executed by a control unit (not illustrated in FIG. 2) including a calculation apparatus, such as a central processing unit (CPU). The control unit controls the entire camera by sending a control command to each unit in response to a user operation, and includes various function units, such as a tracking unit (described below). In step S401, the control unit receives information about a predicted movement locus of the tracking target object. In the present exemplary embodiment, the user inputs a movement locus of the object on the touch panel display 116 disposed on the rear surface of the camera by using a finger or a touch pen. Before inputting a movement locus, the user fixes the camera, and selects the live view mode in which the user can observe the status of the object in real time on the touch panel display 116. In the live view mode, the touch panel display 116 displays an object image caught by the AE sensor 111, or an image signal of an object captured by the image sensor 108 with the main mirror 103 and the sub mirror 104 retracted from the imaging optical path. Thus, while monitoring the entire composition, the user can specify a predicted movement locus of the object by tracing a desired locus in the composition. When the user wants to capture an image of the car turning at the hairpin curve of the circuit as illustrated in FIG. 1, the user only needs to trace the arrow indicated by a dotted line illustrated in FIG. 1. When the camera body 101 has acquired movement locus information of the object and stored the information in a storage unit, the processing proceeds to step S402. Specifically, in step S401, the control unit stores information about a predicted movement locus of the object in the composition (the movement locus information including information about a position to which the object is predicted to move in the screen).

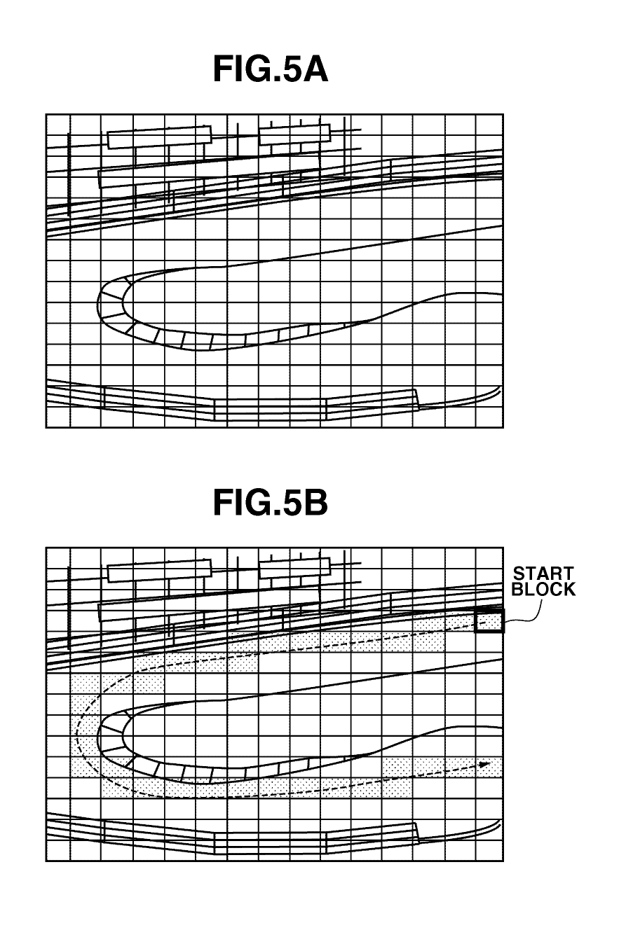

In step S402, the control unit performs ranging for a plurality of points in the screen. The movement locus of the object at the time of image capturing has been acquired in step S401. However, it cannot necessarily be determined that the car (tracking target object) will pass the movement locus given in step S401 because of an accident, such as crashing at the hairpin curve. Accordingly, the control unit performs pre-ranging not only on the movement locus but also at a plurality of points in the screen. In the present exemplary embodiment, as illustrated in FIG. 5A, the control unit divides the screen into 225 (15×15) block regions, and performs ranging for each region by using the contrast detection system. The contrast detection AF system is a well-known technique, and detailed description of operations will be omitted. An outline is that the contrast detection AF system calculates a contrast value of an image signal within a certain range while moving a focus lens (not illustrated) existing in the photographic lens 102, and sets as an in-focus point a focus lens position where the contract value is maximized. In the example illustrated in FIG. 5A, the control unit calculates the contrast value for each of the 225 block regions while moving the focus lens, and stores a focus lens position where the contrast value is maximized in each region, thus performing ranging at all of the 225 points. In step S402, the control unit performs pre-ranging at a plurality of points including at least the plurality of block regions on the movement locus based on the stored movement locus information. When the control unit has performed ranging at the plurality of points in the screen in step S402, the processing proceeds to step S403. In this case, the user may change a method for dividing the screen into block regions (the number, layout, size, and shape of blocks) depending on the situation. Further, as a method for inputting a movement locus, the user may suitably select division block regions.

In step S403, the control unit performs processing for limiting a focus lens drive range at the time of actual image capturing based on the result of the ranging performed in step S402. When the control unit overlaps the predicted movement locus of the object pre-input in step S401 with the 225 small regions illustrated in FIG. 5A, it turns out that the object moves in the 36 regions (shaded regions) illustrated in FIG. 5B. Therefore, driving the focus lens only in a section between a result of ranging on the nearest side and a result of ranging on the farthest side in the 36 regions enables quick driving of the focus lens because of a drive section limitation. The control unit preferably limits a focus lens drive range D so that the following formula is satisfied:

(Dₙₑₐᵣ−Dₑₓ)≦D≦(D_{far}+Dₑₓ)

where Dₙₑₐᵣ indicates the result of ranging on the nearest side, D_{far} indicates the result of ranging on the farthest side, and Dₑₓ indicates a certain margin amount held in the camera.

The margin amount Dₑₓ is provided not to affect the focusing operation even if a minor change arises between the result of pre-ranging and the result of ranging at the time of actual object's image capturing. Thus, the control unit may determine a lens drive range corresponding to the range in which the object may exist at the time of image capturing based on the results of ranging at a plurality of points, and limit the lens drive range at the time of the focusing operation to the determined lens drive range. When the control unit has limited the lens drive range, the processing proceeds to step S404.

In step S404, the control unit determines whether the release button 115 is half-pressed, i.e., the SW1 is turned ON by the user. When the SW1 is turned ON (YES in step S404), the processing proceeds to step S405. At the same time when the release button is half-pressed (SW1 is turned ON), the camera starts tracking of the imaging target object, and starts AF and AE operations according to the imaging target object. In the present exemplary embodiment, the user observes the object through the eyepiece 114, and, in the meantime, a real-time image signal of the object is acquired by the AE sensor 111 and used for tracking calculation.

In step S405, to track the imaging target object, the control unit identifies and locks on the position of the imaging target object in the screen. Since the object movement locus is input by the user in step S401, at the moment when tracking is started, i.e., at a timing when the SW1 is turned ON, the imaging target object is expected to exist in the proximity of the starting point of the locus of the object. Therefore, in step S405, the control unit stores as a tracking target the image signal in the START block illustrated in FIG. 5B at the timing when the SW1 is turned ON. When the control unit stores the image signal as a tracking target in step S405, the processing proceeds to step S406. Thus, the camera includes an operation unit (the above-described release button) which allows the user to instruct the camera to start the tracking operation. At the moment when the user operates the operation unit, the control unit registers image information in the proximity of the starting point of the movement locus of the object as a tracking target template, and starts tracking operation.

In step S406, the control unit tracks the position of the imaging target object in the screen. In the object tracking step, by using the tracking target image signal as a template image signal, the control unit performs the two-dimensional correlation calculation between the template image signal and the image signal of the following frame to calculate how much and which direction the imaging target object has moved in the screen. In this calculation, the control unit performs processing for achieving matching by the two-dimensional correlation calculation with the template image signal, and recognizing as a move destination of the object a position where best matching is made. The processing is referred to as motion vector calculation processing which is widely used, for example, in processing for finding a human face in an image signal. The motion vector calculation processing is a well-known technique, and detailed description of operations will be omitted. In the present exemplary embodiment, by using as a template image signal the image signal in the START block illustrated in FIG. 5B in a frame at the moment when the SW1 is turned ON, the control unit performs the two-dimensional correlation calculation with an image signal in the following frame. Then, the control unit calculates a block at a position having the highest correlation as a move destination of the imaging target object. In the above-described two-dimensional correlation calculation, although the control unit generally changes the mutual positional relation between the template image signal and the image signal subjected to matching in diverse ways to calculate the amount of correlation, the movement locus of the object is pre-known in the present exemplary embodiment. Therefore, the control unit preferentially performs the correlation calculation with a portion (block) of the move destination of the object presumed from the movement locus. If the reliability R of the result of the calculation is higher than a predetermined threshold value R_{TH}, the control unit determines the position as a move destination of the imaging target object. This processing enables the camera to reduce calculation load and improve processing speed. When a move destination of the imaging target object is determined, the control unit registers an image signal for the new move destination as a template image signal, and performs the two-dimensional correlation calculation with an image signal in the following frame. The control unit keeps identifying a position of the moving imaging target object in the screen in this way, thus tracking the object. As described above, the camera includes a tracking unit for detecting the movement of the object in the composition to track the object. The tracking unit preferentially compares image information of the detected object with image information of the predicted position, based on the movement locus information including the information about a position to which the object is predicted to move, and performs the above-described calculation for object tracking, thus identifying a position of the object at each timing. When a move destination of the imaging target object has been determined, the processing proceeds to step S407.

The control unit applies the automatic focusing operation to the imaging target object whose position in the screen has been captured. In the automatic focusing operation, the control unit activates the phase-difference AF sensor having the ranging point layout illustrated in FIG. 3A. Then, if a ranging point of the phase-difference AF sensor exists at the position of the imaging target object currently being tracked, the control unit performs the automatic focusing operation by using the relevant ranging point. At the time of the actual image capturing operation, when the object comes to a point at which pre-ranging has been performed, the control unit performs the focusing operation based on the result of the pre-ranging. Alternatively, the control unit may drive the focus lens based on the result of ranging in the block closest to the position where the imaging target object exists out of the results of pre-ranging performed in the 225 blocks in step S402. Ranging by using the phase-difference AF sensor acquires a result of ranging at a timing where the object actually exists and therefore provides real-time metering. However, this method has a disadvantage that ranging can be performed only at limited points (ranging points) in the screen. On the contrary, the pre-ranging performed based on the contrast detection system in step S402 enables ranging at all of points in the screen, although it does not provide real-time metering. Therefore, if a ranging point of the phase-difference AF sensor exists at a position where the imaging target object currently being tracked exists, as the point C illustrated in FIG. 3B (YES in step S407), then in step S408, the control unit drives the focus lens based on the result of ranging of the phase-difference AF sensor. Otherwise, if the ranging point of the phase-difference AF sensor does not exist at the position where the imaging target object exists, as the points A and B illustrated in FIG. 3B (NO in step S407), then in step S412, the control unit drives the focus lens based on the result of pre-ranging based on the contrast detection system.

As described above, the camera includes a first AF unit (the above-described phase-difference AF sensor) for performing ranging at the above-described object position identified at the time of image capturing, and a second AF unit (the above-described contrast detection AF unit) for performing pre-ranging in a region including a plurality of points on the locus based on the movement locus information. The camera may be configured to perform the focusing operation by using an AF unit selected by a selection unit for selecting one of the two AF units. As described above, the first AF unit limits the positions of ranging points at which automatic focusing detection can be performed. If an object exists in the proximity of the ranging points, the control unit performs the focusing operation by using the first AF unit. Otherwise, if an object does not exist in the proximity of the ranging points, the control unit performs the focusing operation based on the result of pre-ranging.

In steps S408 to S411, the control unit drives the focus lens based on the output of the phase-difference AF sensor. In step S408, the control unit calculates the amount of drive of the focus lens required for achieving the in-focus state based on information about a ranging point at a portion (block) at which the imaging target object exists. Regularly, it is desirable that the control unit drives the focus lens based on the result of the calculation. However, if a shielding object, such as a person, crosses between the object and the camera, if the imaging target object is moving at very high speed, or, if the result of ranging has low reliability because of low contrast of the object, incorrect ranging may result. In this case, therefore, it is more desirable to drive the focus lens based on the result of ranging preacquired in step S402. In steps S409 and S410, the control unit excludes the case of incorrect ranging. In the present exemplary embodiment in which the movement locus of the object is pre-known, the rough distance to the object is pre-known based on the movement locus information including the information about a position to which the object is predicted to move in the screen. The lens drive range corresponding to the relevant range is stored in step S403. Therefore, if the following condition is satisfied, incorrect ranging is highly likely to have occurred:

D<(Dₙₑₐᵣ−Dₑₓ) or (D_{far}+Dₑₓ)<D

where D indicates the result of ranging.

In this case, the control unit uses the result of pre-ranging based on the contrast detection system (step S409).

With the tracking target object, it is less likely that the result of ranging rapidly changes. If the result of ranging rapidly changes, it is considered that out of focus to the background has occurred. In step S410, therefore, the control unit compares a ranging result Dₚᵣₑᵥ for the preceding frame with a ranging result D_{cur} for the current frame to determine whether the change is larger than a predetermined amount D_{TH} stored in the camera. Specifically, if |Dₚᵣₑᵥ−D_{cur}|≧D_{TH} is satisfied, the control unit determines that out of focus has occurred (YES in step S410), then in step S412, the control unit drives the focus lens based on the result of pre-ranging based on the contrast detection system. Thus, the camera includes a unit for performing the prediction AF mode in which ranging is successively performed in the time direction to predict the motion of the object and then the focusing operation is performed in consideration of a time lag between ranging and image capturing. The camera further includes a unit for performing an out-of-focus detection function for detecting an out-of-focus phenomenon due to a sudden change in the result of ranging (i.e., a phenomenon in which out of focus is determined to have occurred by the detection of a predetermined or larger change in the result of ranging) in the prediction AF mode. When the out-of-focus detection function is activated, the control unit performs the focusing operation based on the result of pre-ranging.

Otherwise, if |Dₚᵣₑᵥ−D_{cur}|≧D_{TH} is not satisfied (NO in step S410), then in step S411, the control unit drives the focus lens based on the output of the phase-difference AF sensor acquired in step S408. Then, the processing proceeds to step S413 to exit the AF sequence.

In the first exemplary embodiment, the control unit performs pre-ranging at a plurality of points (a plurality of blocks) in the screen in step S402. Therefore, the following camera configuration may be assumed. Specifically, the camera acquires an imaging condition under which the results of ranging at all of ranging points on the movement locus of the object fall within the depth of field, based on the results of ranging at the plurality of points, performs image capturing under this imaging condition, and, therefore, does not perform focusing control at the time of actual image capturing.

While the present invention has specifically been described based on the above-described exemplary embodiments, the present invention is not limited thereto but can be modified in diverse ways within the ambit of the appended claims. The technical elements described in the specification or the drawings can exhibit technical usefulness, either alone or in combination, and combinations are not limited to those described in the claims as filed.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

This application claims the benefit of Japanese Patent Application No. 2012-165337 filed Jul. 26, 2012, which is hereby incorporated by reference herein in its entirety.

What is claimed is:

1. An object ranging apparatus comprising:
a first ranging unit configured to, based on movement locus information including a series of loci of positions to which an object is predicted to move, perform ranging at a plurality of predicted positions on the loci;
a storage unit configured to store results of ranging at the plurality of predicted positions; and
a control unit configured to, when the object reaches the predicted positions in an actual image capturing operation, perform a focusing operation based on the results of ranging at the predicted positions.

2. The object ranging apparatus according to claim 1, further comprising a tracking unit configured to detect movement of the object and track the object,
wherein, the tracking unit compares image information of the object detected in the actual image capturing operation with image information of the object at the predicted positions, and identifies a position to which the object has moved in the actual image capturing operation.

3. The object ranging apparatus according to claim 1, wherein the control unit calculates a predicted focus lens drive range corresponding to a ranging range in which the object is likely to exist in the actual image capturing operation based on the results of ranging at the plurality of predicted positions, and limits a focus lens drive range at the time of the focusing operation in the actual image capturing operation to the predicted focus lens drive range.

4. The object ranging apparatus according to claim 1, wherein, when reliability of a result of ranging at the time of the focusing operation in the actual image capturing operation is lower than a predetermined threshold value, the control unit performs the focusing operation based on the results of ranging at the predicted positions.

5. The object ranging apparatus according to claim 1, wherein the control unit calculates, based on the results of ranging at the plurality of predicted positions, an imaging condition under which the results of ranging at all of the ranging positions in the actual image capturing operation fall within a depth of field, and performs imaging under the imaging condition.

6. The object ranging apparatus according to claim 2, further comprising a second ranging unit configured to perform ranging of the object currently being tracked by the tracking unit at the time of the actual image capturing operation within a limited range, in which the ranging is performable, in a photographing screen,
wherein, when the object is positioned out of the range in which the ranging is performable, the control unit performs the focusing operation by using the first ranging unit.

7. The object ranging apparatus according to claim 6, wherein the first ranging unit includes a contrast focus adjustment unit, and the second ranging unit includes a phase-difference focus adjustment unit.

8. An imaging apparatus comprising:
the object ranging apparatus according to claim 1; and
an image sensor configured to acquire image information of the object.

9. An object ranging method comprising:
performing, based on movement locus information including a series of loci of positions to which an object is predicted to move, to range at a plurality of predicted positions on the loci;
storing results of ranging at the plurality of predicted positions; and
performing, when the object reaches the predicted positions in an actual image capturing operation, a focusing operation based on the results of ranging at the predicted positions.
